(19) United States
(12) Patent Application Publication
(10) Pub. No.: US 2025/0252586 A1
(43) Pub. Date: Aug. 7, 2025

(54) INFORMATION PROCESSING APPARATUS AND RECORDING MEDIUM

(71) Applicant: SUMITOMO HEAVY INDUSTRIES, LTD., Tokyo (JP)

(72) Inventor: Fang XU, Kanagawa (JP)

(21) Appl. No.: 19/093,828

(22) Filed: Mar. 28, 2025

Related U.S. Application Data
(63) Continuation of application No. PCT/JP2023/035382, filed on Sep. 28, 2023.

(30) Foreign Application Priority Data
Sep. 29, 2022 (JP) 2022-156595

(51) Int. Cl. G06T 7/50; G06T 7/70; G06V 10/74; G06V 20/70

(52) U.S. Cl. CPC G06T 7/50; G06T 7/70; G06V 10/761; G06V 20/70

(57) ABSTRACT

An information processing apparatus includes a processor and memory storing instructions for executing a process including acquiring first sensing data representing a shape of a narrow range of a first target object, and second sensing data representing a shape of a wide range of the first target object and for which a relationship between sensors at data acquisition is predefined; acquiring a third sensing data group including third sensing data representing a shape of a narrow range of a second target object, and a fourth sensing data group including fourth sensing data representing a shape of a wide range of the second target object and for which a relationship between sensors at data acquisition is predefined; and associating the first sensing data with the third sensing data representing a portion of the second target object same as a portion of the first target object corresponding to the first sensing data.

### CROSS-REFERENCE TO RELATED APPLICATIONS

This application is a continuation application filed under 35 U.S.C. 111(a) claiming benefit under 35 U.S.C. 120 and 365(c) of PCT International Application No. PCT/JP2023/035382 filed on Sep. 28, 2023, and designating the U.S., which claims priority to Japanese Patent Application No. 2022-156595, filed on Sep. 29, 2022. The entire contents of the foregoing applications are incorporated herein by reference.

### BACKGROUND

### 1. Technical Field The present disclosure relates to an information processing apparatus, and the like.

### 2. Description of Related Art

For example, a related-art technique for inspecting an object using sensing data such as image data is disclosed.

### SUMMARY

According to an embodiment of the present disclosure, an information processing apparatus includes:
a processor; and
a memory storing instructions that cause the processor to execute a process, the process including
acquiring first sensing data and second sensing data, the first sensing data representing a shape of a relatively narrow range of a first target object, and the second sensing data representing a shape of a relatively wide range of the first target object and for which a relationship in position and orientation between sensors at a time of acquisition of the first sensing data and the second sensing data is predefined with respect to the first sensing data;
acquiring a third sensing data group and a fourth sensing data group, the third sensing data group being a collection of third sensing data, the third sensing data representing a shape of a relatively narrow range of a second target object, the second target object being a comparison target of the first target object, and the fourth sensing data group being a collection of fourth sensing data, the fourth sensing data representing a shape of a relatively wide range of the second target object and for which a relationship in position and orientation between the sensors at a time of acquisition of the third sensing data and the fourth sensing data is predefined with respect to the third sensing data; and
associating, based on the second sensing data and the fourth sensing data group, the first sensing data with the third sensing data, the third sensing data representing a portion of the second target object that is a same portion as a portion of the first target object corresponding to the first sensing data.

According to another embodiment of the present disclosure, an information processing apparatus includes:
a processor; and
a memory storing instructions that cause the processor to execute a process, the process including
acquiring a first sensing data group and a second sensing data group, the first sensing data group being a collection of first sensing data, the first sensing data representing a shape of a relatively narrow range of a first target object, and the second sensing data group being a collection of second sensing data, the second sensing data representing a shape of a relatively wide range of the first target object and for which a relationship in position and orientation between sensors at a time of acquisition of the first sensing data and the second sensing data is predefined with respect to the first sensing data;
storing three dimensional shape data of a second target object as a comparison target of the first target object and a third sensing data group, the third sensing data group being a collection of third sensing data, the third sensing data representing a shape of the second target object and for which a correspondence relationship with a portion of the second target object or the three dimensional shape data is predefined; and
associating, based on the second sensing data group and the three dimensional shape data of the second target object, the first sensing data and the third sensing data, the first sensing data representing a portion of the first target object, and the third sensing data representing a portion of the second target object that is a same portion as the portion of the first target object.

According to still another embodiment of the present disclosure, an information processing apparatus includes:
a processor; and
a memory storing instructions that cause the processor to execute a process, the process including
acquiring a first sensing data group and a second sensing data group, the first sensing data group being a collection of first sensing data, the first sensing data representing a shape of a relatively narrow range of a first target object, and the second sensing data group being a collection of second sensing data, the second sensing data representing a shape of a relatively wide range of the first target object and for which a relationship in position and orientation between sensors at a time of acquisition of the first sensing data and the second sensing data is defined in advance; and
associating the second sensing data with a portion of the first target object represented by the second sensing data, based on the first sensing data group.

According to yet another embodiment of the present disclosure, a non-transitory computer-readable recording medium storing a program, wherein when executed by a processor of an information processing apparatus, causes the information processing apparatus to execute a process, the process including:
acquiring first sensing data and second sensing data, the first sensing data representing a shape of a relatively narrow range of a first target object, and the second sensing data representing a shape of a relatively wide range of the first target object and for which a relationship in position and orientation between sensors at a time of acquisition of the first sensing data and the second sensing data is predefined with respect to the first sensing data;
acquiring a third sensing data group and a fourth sensing data group, the third sensing data group being a collection of third sensing data, the third sensing data representing a shape of a relatively narrow range of a second target object, the second target object being a comparison target of the first target object, the fourth sensing data group being a collection of fourth sensing data, the fourth sensing data representing a shape of a relatively wide range of the second target object and for which a relationship in position and orientation between the sensors at a time of acquisition of the third sensing data and the fourth sensing data is predefined with respect to the third sensing data; and
associating, based on the second sensing data and the fourth sensing data group, the first sensing data with the third sensing data, the third sensing data representing a portion of the second target object that is a same portion as a portion of the first target object corresponding to the first sensing data.

### BRIEF DESCRIPTION OF THE DRAWINGS

FIG. 1 is a diagram schematically illustrating an example of an inspection support system.

FIG. 2 is a diagram schematically illustrating another example of the inspection support system.

FIG. 3 is a view illustrating a specific example of an inspection target object.

FIG. 4 is a view illustrating a specific example of an inspection target object.

FIG. 5 is a view illustrating a specific example of an inspection target object.

FIG. 6 is a diagram illustrating an example of a hardware configuration of an inspection support apparatus.

FIG. 7 is a functional block diagram illustrating a first example of the configuration of the inspection support apparatus.

FIG. 8 is a functional block diagram illustrating a second example of the configuration of the inspection support apparatus.

FIG. 9 is a diagram illustrating a first example of a screen displayed on a display device.

FIG. 10 is a diagram illustrating a second example of a screen displayed on the display device.

FIG. 11 is a diagram illustrating a third example of a screen displayed on the display device.

### DETAILED DESCRIPTION

In related-art technique, for example, when sensing data representing a shape of a relatively narrow range, such as image data having a relatively narrow viewing angle, is used, the data can reflect a detailed shape of that range. Therefore, the state of that range of a target object can be determined in more detail.

However, in the sensing data representing the shape of a relatively narrow range, it may not be possible to determine which range of the overall inspection target range of the target object the data corresponds to. Therefore, for example, sensing data of a portion of an inspection target cannot be appropriately extracted from the sensing data group, and as a result, there is a possibility that inspection cannot be appropriately performed.

In a case where sensing data representing a shape of a relatively wide range such as image data having a relatively wide viewing angle is used, it is easier to determine the portion of the target object corresponding to a range of data within the overall inspection target range of the target object.

However, in the sensing data representing a shape of a relatively wide range, a detailed shape is less likely to be reflected in the data. Therefore, the state of the range included in the sensing data cannot be determined in detail, and as a result, there is a possibility that the inspection cannot be appropriately performed.

It is desirable to provide a technique capable of more appropriately inspecting a target object by using sensing data.

According to the above-described embodiments, it is possible to more appropriately inspect a target object using the sensing data.

Hereinafter, embodiments will be described with reference to the accompanying drawings.

### Overview of Inspection Support System

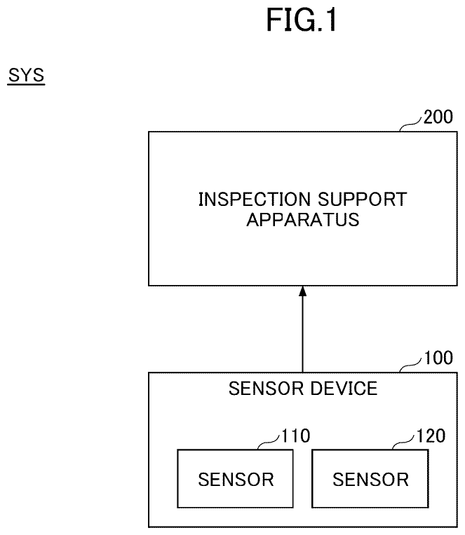

First, an example of an inspection support system SYS according to the present embodiment will be described with reference to FIGS. 1 to 5.

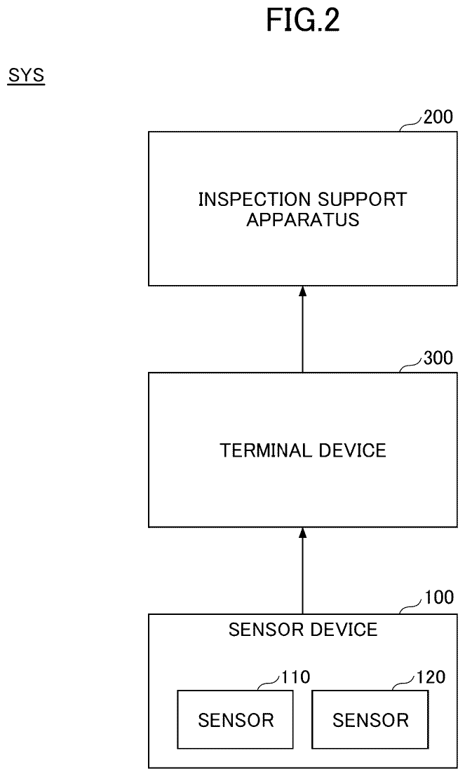

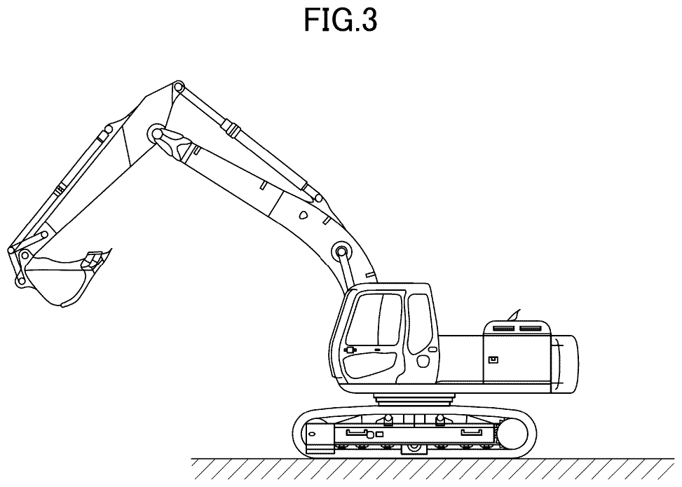

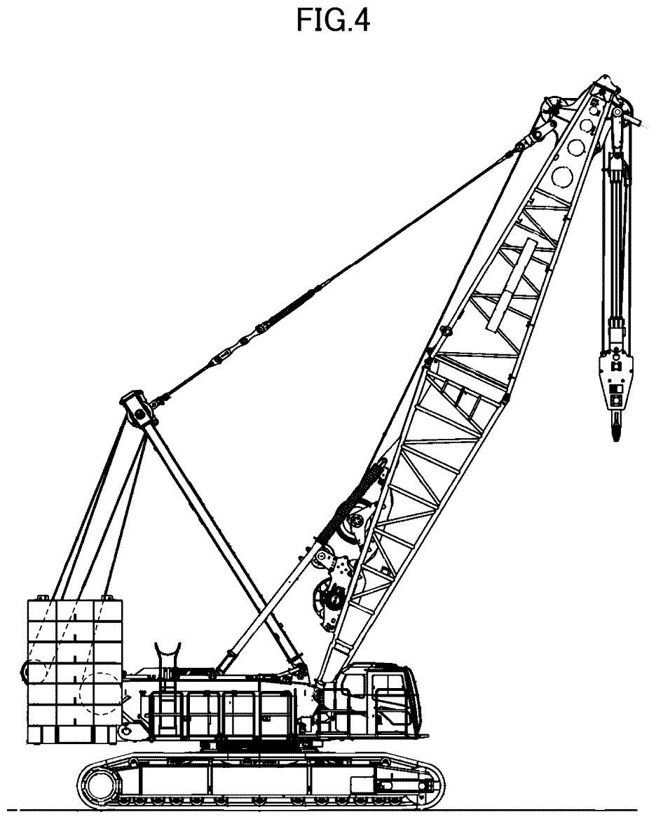

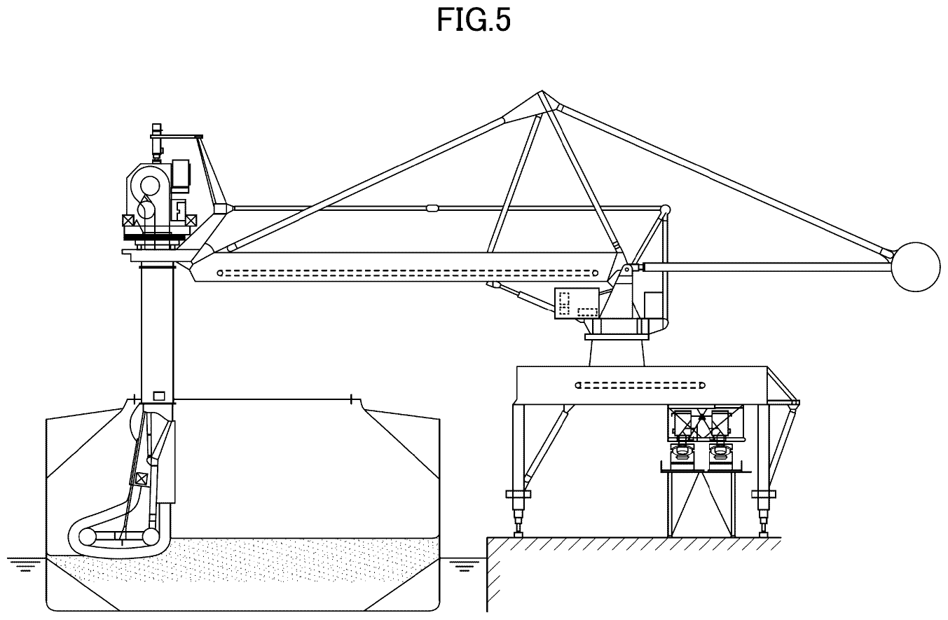

FIG. 1 is a diagram illustrating an example of an inspection support system SYS. FIG. 2 is a diagram illustrating another example of the inspection support system SYS. FIGS. 3 to 5 are views illustrating specific examples of an inspection target object. Specifically, FIG. 3 is a side view illustrating an excavator as an example of the inspection target object. FIG. 4 is a side view illustrating a mobile crane (crawler crane) as another example of the inspection target object. FIG. 5 is a side view illustrating a continuous unloader as still another example of the inspection target object.

The inspection support system SYS supports an inspection (hereinafter, referred to as a “comparison inspection” for convenience) of a difference between an inspection target object and a comparison target by a user.

The inspection target object is, for example, a large structure. The large structure as an inspection target includes, for example, a large machine. The large machine includes, for example, a work machine such as an excavator, a mobile crane (crawler crane), or a continuous unloader as illustrated in FIGS. 3 to 5. The large machine may include a large ship. The large structure as the inspection target includes, for example, a large plant (a building of a factory or equipment of a factory). The large plant includes, for example, a building or equipment of a power plant, a building or equipment of a steel mill, and the like. The inspection target object includes a large civil engineering structure and a large architectural structure. The large civil engineering structures include, for example, road facilities, railroad facilities, dams, bridges, airport facilities, harbor facilities, and the like. The large architectural structures include, for example, skyscrapers, large sports competitions (stadiums), etc.

The comparison inspection includes, for example, inspection of a change in the inspection target object with respect to a previous state, that is, inspection of a change in the inspection target object in time series. In this case, the comparison target object is a previous inspection target object itself. The change in the inspection target object in time series includes, for example, the occurrence of rust, deformation, the occurrence of scratches, the occurrence of loosening of a screw, the occurrence of missing components, remodeling, the occurrence of discoloration, and relative displacement with respect to the surroundings due to an earthquake or the like. The comparison inspection includes inspection of a difference between the inspection target object and the comparison target object of a type the same (same design) as the inspection target object. In this case, the comparison target object is, for example, a product that has passed the inspection at the median of the tolerance among prototypes of products having the same design as the inspection target object and initial lots thereof. The difference between the inspection target object and the different comparison target object of the same type (same design) includes, for example, a difference in shape or color exceeding an assumed manufacturing error, the presence or absence of a shortage of components, and the like.

The range of the comparison inspection may be the entirety or a part of the inspection target object and the comparison inspection object. Hereinafter, a case where the range of the comparison inspection is the entirety of the inspection target object and the comparison inspection object will be mainly described.

Further, a plurality of comparison target objects may be used. For example, in the case of inspection of a change in an inspection target object in time series, inspection of comparison between a current inspection target object and a plurality of comparison target objects corresponding to the inspection target object at a plurality of different previous time points is performed.

As illustrated in FIG. 1, the inspection support system SYS includes, for example, a sensor device 100 and an inspection support apparatus 200. As illustrated in FIG. 2, the inspection support system SYS may further include a terminal device 300.

The sensor device 100 acquires sensing data related to the shape of an inspection target object or a comparison target object. For example, the sensor device 100 acquires sensing data related to the shape of the inspection target object or the comparison target object in response to an operation of the worker. The sensor device 100 may acquire sensing data related to the shape of the inspection target object or the comparison target object in accordance with the movement of the worker who carries the sensor device 100. The sensor device 100 may be configured to be movable like a drone, for example. In this case, the sensor device 100 acquires sensing data related to the shape of the inspection target object or the comparison target object in response to an operation from the outside while moving in response to an operation from the outside, for example. The sensor device 100 may automatically acquire sensing data related to the shape of the inspection target object or the comparison target object while autonomously moving.

The sensor device 100 includes sensors 110 and 120.

The sensor device 100 may be a device specialized for a function of acquiring sensing data or may be a general-purpose device. For example, the sensor device 100 may be an information device (smart device) equipped with an imaging device, a distance sensor, or the like as the sensors 110 and 120. The information device includes, for example, a smartphone, a tablet terminal, and the like. The sensor device 100 may be a drone on which an imaging device, a distance sensor, or the like is mounted as the sensors 110 and 120.

The sensors 110 and 120 acquire sensing data related to the shapes of the inspection target object and the comparison target object, respectively.

For example, the sensors 110 and 120 are an imaging device capable of acquiring a captured image (image data) in which the shape of the inspection target object is reflected. The imaging device is, for example, a monocular camera. The imaging device may be a stereo camera, an RGB-D camera, a TOF (Time Of Flight) camera, or the like. The camera may be a camera (hereinafter, referred to as a “3D camera” for convenience) capable of acquiring depth information in addition to a two dimensional image. The sensors 110 and 120 may be a distance sensor. The distance sensor may be, for example, a distance sensor capable of acquiring point group data corresponding to the shape of the inspection target object with reference to the sensor device 100 (sensors 110 and 120). The distance sensor includes, for example, a light detecting and ranging (LiDAR) sensor, a millimeter wave radar, an ultrasonic sensor, and the like. Further, one of the sensors 110 and 120 may be an imaging device, and the other may be a distance sensor.

The sensor 110 is a sensor having a wider sensing range than the sensor 120. Thus, the sensor 110 can acquire sensing data representing the shape of the inspection target object over a wider range than the sensor 120. Hereinafter, the sensing data acquired by the sensor 110 may be referred to as “wide angle data” for convenience. The sensor 110 is, for example, an omnidirectional camera.

The sensor 120 is a sensor having a narrower sensing range than the sensor 110. Thus, the sensor 120 can acquire sensing data representing a detailed shape of a relatively narrow range of the inspection target object. Hereinafter, the sensing data acquired by the sensor 120 may be referred to as “narrow angle data” for convenience.

The sensors 110 and 120 are fixed in the relative position and orientation. In addition, the sensors 110 and 120 are synchronized in the acquisition timing of sensing data. Thus, when the sensor device 100 is present at a certain position, both the wide angle data and the narrow angle data are acquired by the sensors 110 and 120.

The sensing data (the wide angle data and the narrow angle data) related to the shapes of the inspection target object and the comparison target object may be acquired by the same sensor device 100 or may be acquired by different sensor devices 100. In the latter case, the sensor device 100 that acquires the sensing data related to the shape of the inspection target object and the sensor device 100 that acquires the sensing data related to the shape of the comparison target object may have different relative positional relationships of the sensors 110 and 120.

The sensing data (the wide angle data and the narrow angle data) acquired by the sensor device 100 is incorporated into the inspection support apparatus 200.

For example, the sensor device 100 transmits the sensing data to the inspection support apparatus 200 through a predetermined communication network. The predetermined communication network includes, for example, a wide area network (WAN). The wide area network includes, for example, a mobile communication network having a base station as a terminal, a satellite communication network using a communication satellite, and the Internet. The predetermined communication network may include a local area network (LAN). The predetermined communication network may include a short-range communication line based on a communication standard such as Bluetooth (registered trademark) or WiFi. For example, as illustrated in FIG. 1, the sensor device 100 directly transmits sensing data to the inspection support apparatus 200. As illustrated in FIG. 2, the sensor device 100 may transmit the sensing data to the inspection support apparatus 200 through the terminal device 300 as a relay device.

The sensing data acquired by the sensor device 100 may be stored in a portable recording medium from the sensor device 100 and may be imported into the inspection support apparatus 200 from the recording medium. The recording medium is, for example, a flash memory such as a hard disk drive (HDD), a solid state drive (SSD), a USB memory, or an SD card.

The inspection support apparatus 200 supports a comparison inspection performed by a user. For example, the inspection support apparatus 200 provides information for a comparison inspection to the user based on the sensing data (the wide angle data and the narrow angle data) input from the sensor device 100.

The inspection support apparatus 200 is, for example, a terminal device (user terminal) used by a user. The user terminal may be a stationary terminal device such as a desktop personal computer (PC). The user terminal may be a mobile (portable) terminal device (portable terminal) such as a smartphone, a tablet terminal, or a laptop PC.

### Hardware Configuration of Inspection Support Apparatus

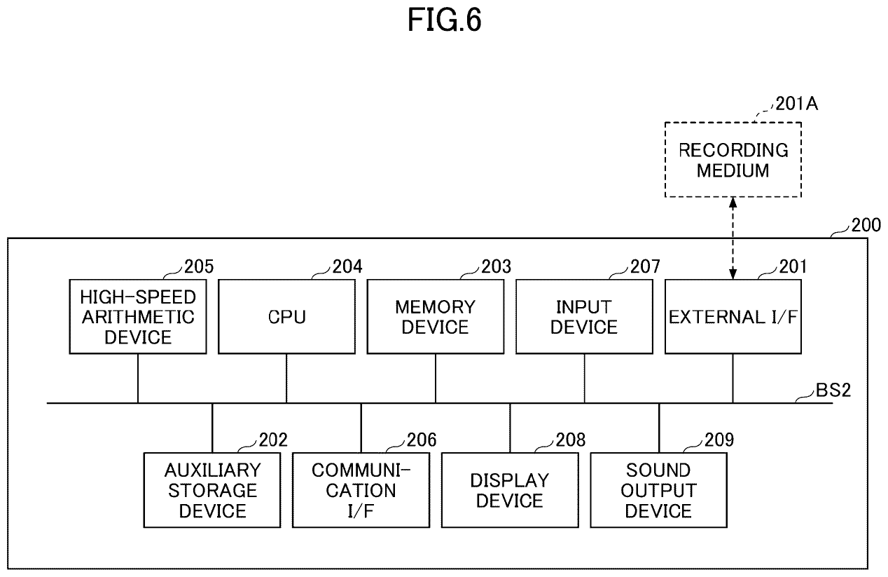

Next, a hardware configuration of the inspection support apparatus 200 will be described with reference to FIG. 6.

FIG. 6 is a block diagram illustrating an example of a hardware configuration of the inspection support apparatus 200.

The functions of the inspection support apparatus 200 are implemented by any given hardware or a combination of any given hardware and software. For example, as illustrated in FIG. 6, the inspection support apparatus 200 includes an external interface (I/F) 201, an auxiliary storage device 202, a memory device 203, a central processing unit (CPU) 204, a high-speed arithmetic device 205, a communication interface (I/F) 206, an input device 207, a display device 208, and a sound output device 209, which are connected via a bus BS2.

The external I/F 201 functions as an interface for reading from the recording medium 201A and writing to the recording medium 201A. The recording medium 201A include, for example, a flexible disk, a CD (Compact Disc), a DVD (Digital Versatile Disc), BD (Blu-ray (trademark) Disc), an SD memory card, a USB-type memory, and the like. The inspection support apparatus 200 can read various kinds of information used in processing and store the information in the auxiliary storage device 202, and can install programs for implementing various functions, through the recording medium 201A.

The inspection support apparatus 200 may acquire various data and programs used in the processing from an external apparatus via the communication I/F 206.

The auxiliary storage device 202 stores the installed various programs, and also stores files, data, and the like necessary for various processes. The auxiliary storage device 202 includes, for example, an HDD, an SSD, or the like.

When an instruction to activate a program is issued, the memory device 203 reads the program from the auxiliary storage device 202 and stores the program. The memory device 203 includes, for example, a dynamic random access memory (DRAM) or a static random access memory (SRAM).

The CPU 204 executes various programs loaded from the auxiliary storage device 202 to the memory device 203 and implements various functions related to the inspection support apparatus 200 according to the programs.

The high-speed arithmetic device 205 performs arithmetic processing at a relatively high speed in conjunction with the CPU 204. The high-speed arithmetic device 205 includes, for example, a graphics processing unit (GPU), an application specific integrated circuit (ASIC), a field-programmable gate array (FPGA), or the like.

The high-speed arithmetic device 205 may be omitted depending on the speed of necessary arithmetic processing.

The communication I/F 206 is used as an interface for connecting to an external device so as to be able to communicate with the external device. The inspection support apparatus 200 can communicate with an external device of the inspection support apparatus 200 via the communication I/F 206. The communication I/F 206 may include a plurality of types of communication interfaces depending on a communication method with a device to be connected.

The input device 207 receives various inputs from a user.

The input device 207 includes, for example, an input device (hereinafter, referred to as an “operation input device”) in a form of receiving a mechanical operation input from a user. The operation device for remote operation may be an operation input device. The operation input device includes, for example, a button, a toggle, a lever, a keyboard, a mouse, a touch panel mounted on the display device 208, a touch pad provided separately from the display device 208, and the like.

The input device 207 may include a voice input device capable of receiving a voice input from the user. The voice input device includes, for example, a microphone capable of collecting a voice of the user.

The input device 207 may include a gesture input device capable of receiving a gesture input from the user. The gesture input device includes, for example, a camera capable of capturing an image of a gesture of the user.

The input device 207 may include a biometric input device capable of receiving a biometric input from the user. The biometric input device includes, for example, a camera capable of acquiring image data containing information on a fingerprint or an iris of the user.

The display device 208 displays an information screen and an operation screen to the user of the inspection support apparatus 200. The display device 208 is, for example, a liquid crystal display or an organic electroluminescence (EL) display.

The sound output device 209 transmits various kinds of information to the user of the inspection support apparatus 200 by sound. The sound output device 209 is, for example, a buzzer, an alarm, a speaker, or the like.

### Functional Configuration of Inspection Support Apparatus

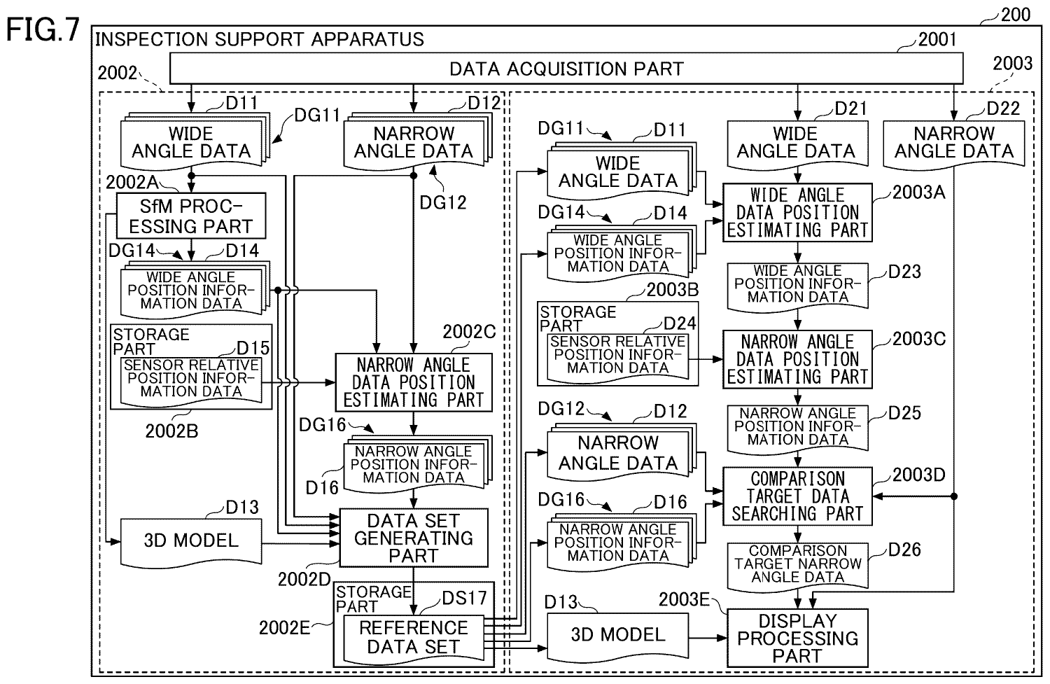

The functional configuration of the inspection support apparatus 200 will be described with reference to FIGS. 7 to 11.

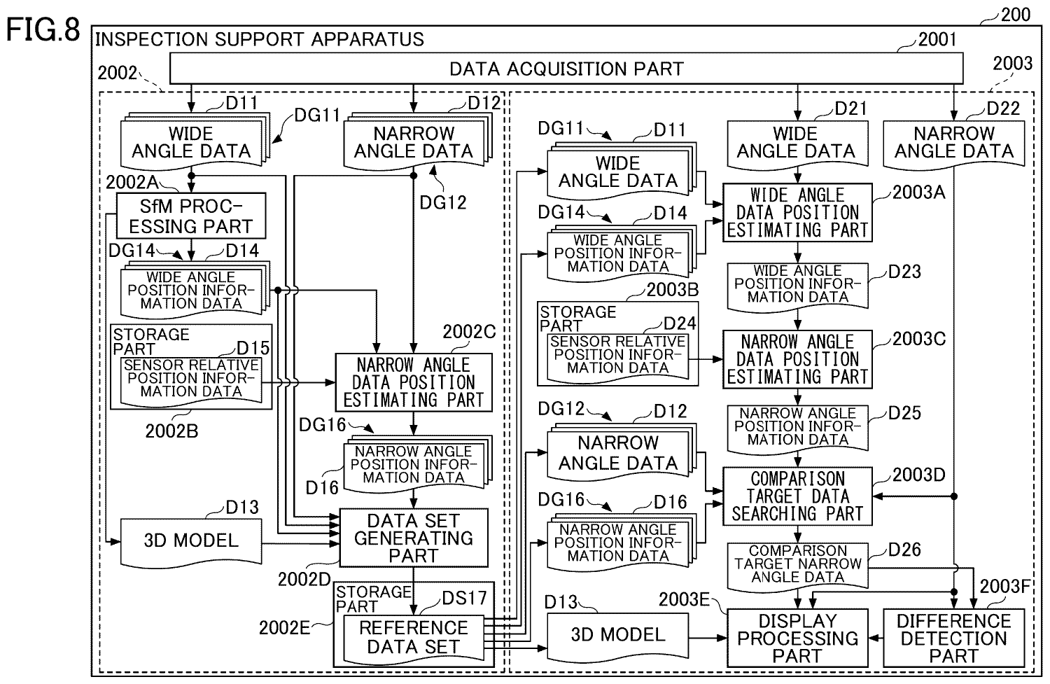

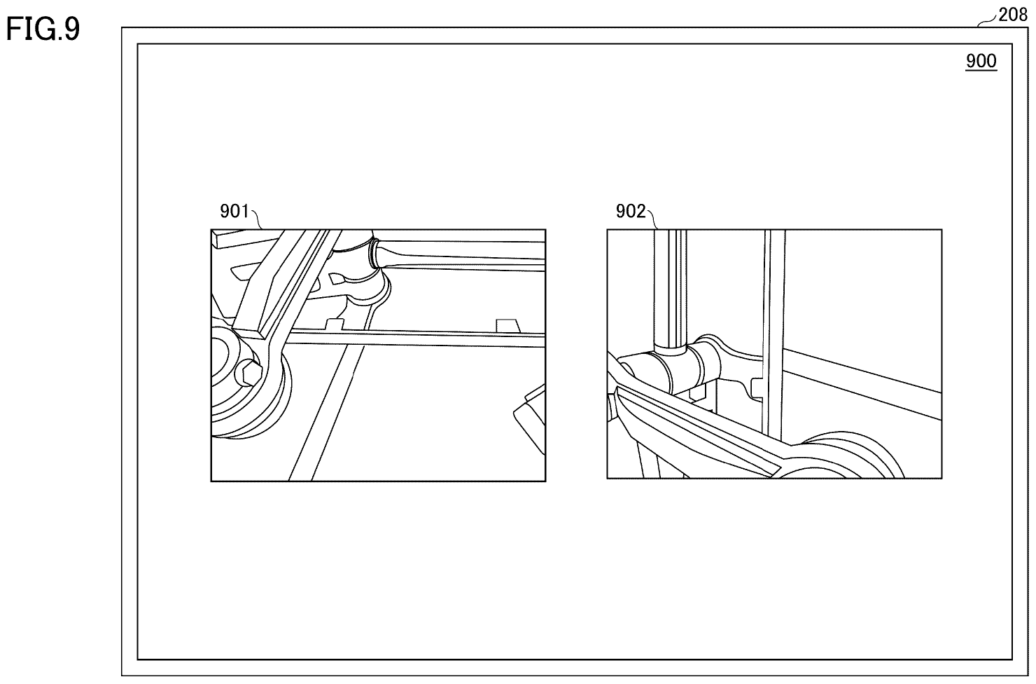

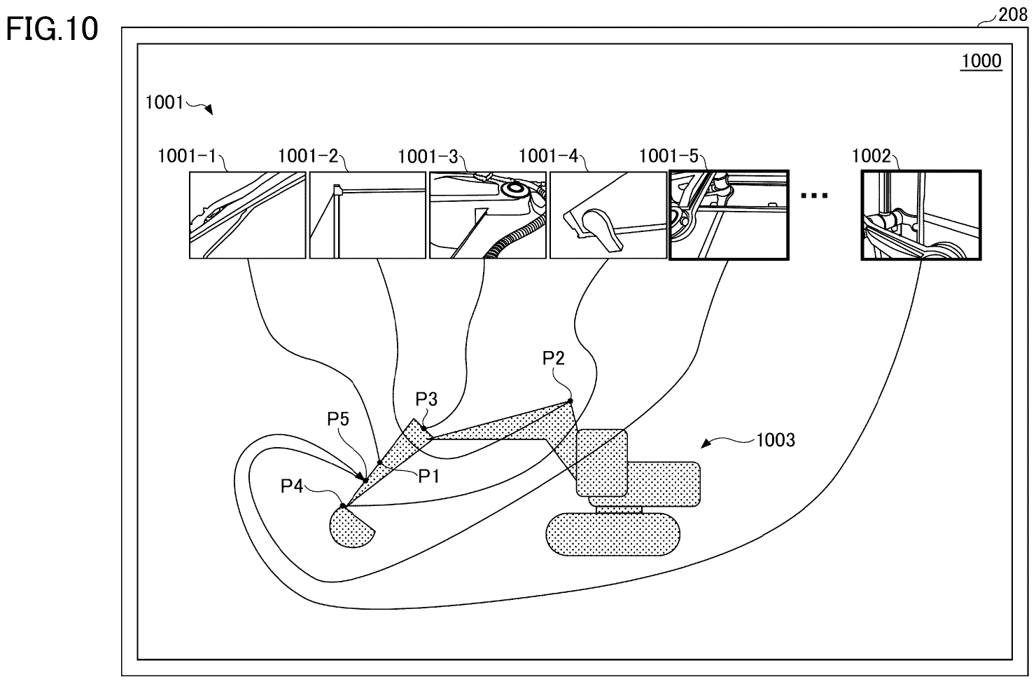

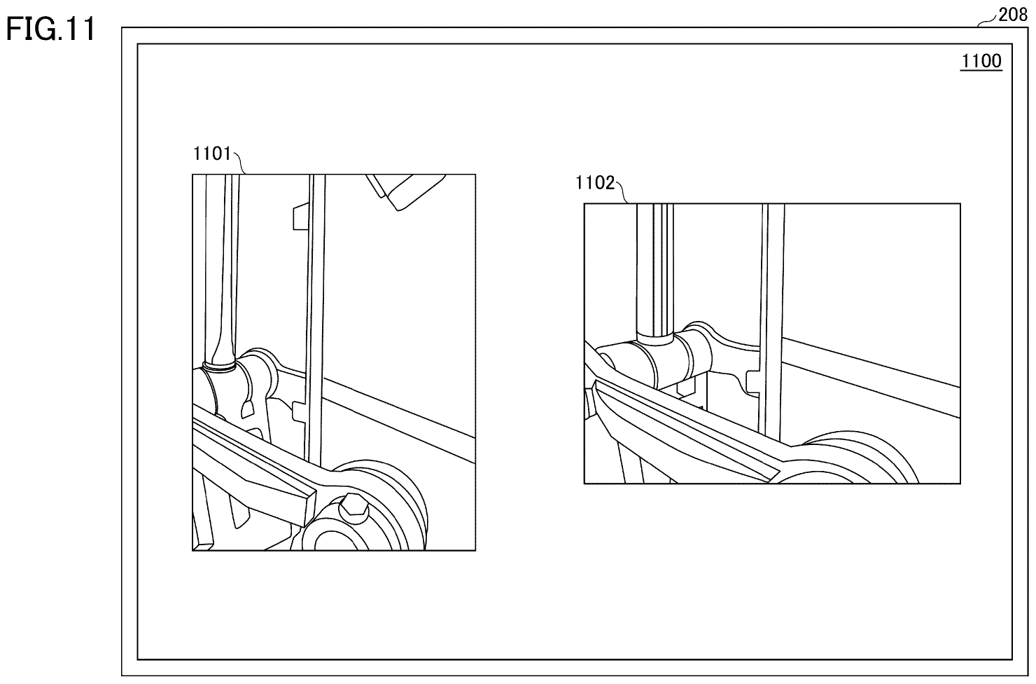

FIG. 7 is a functional block diagram illustrating an example of a configuration of the inspection support apparatus 200. FIG. 8 is a functional block diagram illustrating another example of a configuration of the inspection support apparatus 200. FIG. 9 is a diagram illustrating a first example (screen 900) of a screen displayed on the display device 208. FIG. 10 is a diagram illustrating a second example (screen 1000) of the screen displayed on the display device 208. FIG. 11 is a diagram illustrating a third example (screen 1100) of the screen displayed on the display device 208.

Note that FIGS. 9 to 11 illustrate a case where inspection of a change from a previous state of the excavator as the inspection target object is performed.

Hereinafter, a case where the sensing data is image data will be mainly described.

As illustrated in FIGS. 7 and 8, the inspection support apparatus 200 includes a data acquisition part 2001, a comparison target data generating part 2002, and a comparison inspection support part 2003.

The data acquisition part 2001 acquires sensing data captured from the sensor device 100.

The comparison target data generating part 2002 generates a data set (reference data set DS17) representing the overall shape of the comparison target object, based on the wide angle data group DG11 and the narrow angle data group DG12 representing the shape of the comparison target object, which are acquired by the data acquisition part 2001. The wide angle data group DG11 is a collection of a large number of wide angle data D11, and the narrow angle data group DG12 is a collection of a large number of narrow angle data D12.

For example, unique identification information such as an ID (Identification) is defined for each wide angle data D11. Similarly, unique identification information such as an ID is defined for each narrow angle data D12. As described above, since the acquisition timings of the wide angle data and the narrow angle data by the sensors 110 and 120 are synchronized, the identification information of the wide angle data D11 and the identification information of the narrow angle data D12 acquired at the same timing are associated with each other by a database or the like. Thus, the inspection support apparatus 200 can extract a combination of the wide angle data D11 and the narrow angle data D12 acquired at the same timing (i.e., at the timing when the sensor device 100 is at the same position and in the same orientation) from the wide angle data group DG11 and the narrow angle data group DG12.

The comparison target data generating part 2002 includes a structure from motion (SfM) processing part 2002A, a storage part 2002B, a narrow angle data position estimating part 2002C, a data set generating part 2002D, and a storage part 2002E.

The functions of the SEM processing part 2002A, the narrow angle data position estimating part 2002C, and the data set generating part 2002D are implemented by, for example, loading a program installed in the auxiliary storage device 202 into the memory device 203 and executing the program in the CPU 204. The functions of the storage parts 2002B and 2002E are implemented by storage areas defined in the auxiliary storage device 202 or the like.

The SfM processing part 2002A performs known SfM processing based on the wide angle data group DG11 of the comparison target acquired by the data acquisition part 2001. Thus, the SEM processing part 2002A can output a three dimensional model (3D model) D13 of the comparison target object, and information data on the position and orientation of the sensor 110 corresponding to a target wide angle data D11 (wide angle position information data D14) on a per wide angle data D11 basis. Hereinafter, a collection of wide angle position information data D14 on a per wide angle data D11 basis is referred to as a “wide angle position information data group DG14”.

The position and the orientation of the sensor 110 corresponding to the wide angle data D11 are a relative position and a relative orientation of the sensor 110 with respect to the comparison target object when the wide angle data D11 is acquired.

The storage part 2002B stores sensor relative position information data D15 in advance.

The sensor relative position information data D15 is information data indicating relationships in relative positions and relative orientations of the sensors 110 and 120 in the sensor device 100 that has acquired the sensing data related to the shape of the comparison target object.

The narrow angle data position estimating part 2002C estimates a position and an orientation of the sensor 120 corresponding to a target narrow angle data D12 on a per narrow angle data D12 basis. The narrow angle data position estimating part 2002C outputs information data on the position and orientation of the sensor 120 corresponding to the target narrow angle data D12 (narrow angle position information data D16) on a per narrow angle data D12 basis. Hereinafter, a collection of the narrow angle position information data D16 on a per narrow angle data D12 basis may be referred to as a “narrow angle position information data group DG16”.

The position and the orientation of the sensor 120 corresponding to the narrow angle data D12 are a relative position and a relative orientation of the sensor 120 with respect to the comparison target object when the narrow angle data D12 is acquired.

For example, the narrow angle data position estimating part 2002C extracts a wide angle data D11 associated with identification information on a per narrow angle data D12 basis from the wide angle data group DG11. Subsequently, the narrow angle data position estimating part 2002C extracts the wide angle position information data D14 indicating the position and the orientation of the sensor 110 corresponding to the extracted wide angle data D11 on a per narrow angle data D12 basis from the wide angle position information data group DG14. Then, the narrow angle data position estimating part 2002C calculates the position and the orientation of the sensor 120 corresponding to the narrow angle data D12 on a per narrow angle data D12 basis, based on the extracted wide angle position information data D14 and the sensor relative position information data D15.

The data set generating part 2002D generates a reference data set DS17 including a wide angle data group DG11, a narrow angle data group DG12, a 3D model D13, a wide angle position information data group DG14, and a narrow angle position information data group DG16.

The storage part 2002E stores the reference data set DS17 generated by the data set generating part 2002D.

The comparison inspection support part 2003 supports the comparison inspection by the user based on a wide angle data D21 and a narrow angle data D22 of the inspection target object, and the reference data set DS17 acquired by the data acquisition part 2001.

The wide angle data D21 and the narrow angle data D22 are sensing data acquired by the sensors 110 and 120 at the same timing, that is, when the sensor device 100 is at the same position and in the same orientation.

As illustrated in FIGS. 7 and 8, the comparison inspection support part 2003 includes a wide angle data position estimating part 2003A, a storage part 2003B, a narrow angle data position estimating part 2003C, a comparison target data searching part 2003D, and a display processing part 2003E. As illustrated in FIG. 9, the comparison inspection support part 2003 may include a difference detection part 2003F.

The functions of the wide angle data position estimating part 2003A, the narrow angle data position estimating part 2003C, the comparison target data searching part 2003D, the display processing part 2003E, and the difference detection part 2003F are implemented by, for example, loading a program installed in the auxiliary storage device 202 into the memory device 203 and executing the program by the CPU 204. The function of the storage part 2003B is implemented by a storage area defined in the auxiliary storage device 202 or the like.

The wide angle data position estimating part 2003A estimates the position and the orientation of the sensor 110 corresponding to the wide angle data D21 of the inspection target object, based on the wide angle data group DG11 and the wide angle position information data group DG14 of the comparison target object included in the reference data set DS17. The wide angle data position estimating part 2003A outputs information data on the position and orientation of the sensor 110 corresponding to the wide angle data D21 (wide angle position information data D23).

The position and the orientation of the sensor 110 corresponding to the wide angle data D21 of the inspection target object are a relative position and a relative orientation of the sensor 110 with respect to the inspection target object when the wide angle data D21 is acquired.

For example, the wide angle data position estimating part 2003A extracts, from the wide angle data group DG11 of the comparison target object, one or more pieces of wide angle data of the inspection target object in which the same portion (corresponding point) as the wide angle data D21 of the inspection target object is reflected, by using a known corresponding point search method. The wide angle data position estimating part 2003A estimates (calculates) the position and the orientation of the wide angle data, based on the information data on the position and the orientation of the sensor 110 corresponding to the extracted wide angle data included in the wide angle position information data group DG14.

The storage part 2003B stores sensor relative position information data D24 in advance.

The sensor relative position information data D24 is information indicating relationships in relative positions and relative orientations of the sensors 110 and 120 in the sensor device 100 that has acquired the sensing data related to the shape of the inspection target object.

The narrow angle data position estimating part 2003C estimates the position and the orientation of the sensor 120 corresponding to the narrow angle data D22. The narrow angle data position estimating part 2003C outputs information data (narrow angle position information data D25) on the position and orientation of the sensor 120 corresponding to the narrow angle data D22.

The position and the orientation of the sensor 120 corresponding to the narrow angle data D22 of the inspection target object are the relative position and the relative orientation of the sensor 120 with respect to the inspection target object when the narrow angle data D22 is acquired.

For example, the narrow angle data position estimating part 2003C calculates the position and the orientation of the sensor 120 corresponding to the narrow angle data D22, based on the position information of the sensor 110 corresponding to the wide angle data D21 included in the wide angle position information data D23 and the sensor relative position information data D24.

Note that, when the sensor device 100 that acquires the wide angle data group DG11 and the narrow angle data group DG12 of the comparison target object is the same as the sensor device 100 that acquires the wide angle data D21 and the narrow angle data D22 of the inspection target object, the storage part 2003B may be omitted. In this case, the narrow angle data position estimating part 2003C can estimate the position and the orientation of the sensor 120 corresponding to the narrow angle data D22 by using the sensor relative position information data D15. The function of the narrow angle data position estimating part 2002C and the function of the narrow angle data position estimating part 2003C are substantially the same functions, and are implemented by, for example, the same program installed in the auxiliary storage device 202.

The comparison target data searching part 2003D searches for appropriate narrow angle data D12 as a comparison target for the narrow angle data D22 of the inspection target object, from among the narrow angle data group DG12 of the comparison target object, based on the narrow angle position information data D25 and the narrow angle position information data group DG16. The appropriate narrow angle data D12 as the comparison target for the narrow angle data D22 of the inspection target object is narrow angle data D12 that contains data representing a shape of a same portion (a common portion) as a portion represented by the narrow angle data D22 of the inspection target object (i.e., the same portion is captured), from among the narrow angle data group DG12 of the comparison target object. The comparison target data searching part 2003D outputs, as a search result, one or more narrow angle data D12 as a comparison target narrow angle data D26.

The display processing part 2003E displays the narrow angle data D22 and the comparison target narrow angle data D26 on a display device 208 so as to be compared with each other. The display processing part 2003E may display an image representing an overall shape of the inspection target range of the comparison target object and the inspection target object based on a 3D model D13 of the comparison target object together with the narrow angle data D22 and the comparison target narrow angle data D26.

For example, as illustrated in FIG. 9, the display processing part 2003E causes the display device 208 to display a screen 900.

On the screen 900, an image 901 corresponding to the comparison target narrow angle data D26 and an image 902 corresponding to the narrow angle data D22 are displayed side by side. This enables the user to inspect changes to the inspection target object with respect to the comparison target object (excavator) representing the previous state by comparing images 901 and 902, which depict the same portions (common portions) of the inspection target object and the comparison target object.

As illustrated in FIG. 10, the display processing part 2003E may cause the display device 208 to display a screen 1000.

The screen 1000 displays an image group 1001 corresponding to the narrow angle data group DG12 of the comparison target object, an image 1002 corresponding to the narrow angle data D22 of the inspection target object, and an image 1003 schematically representing the overall shape of the inspection target range of the comparison target object and the inspection target object (excavator). Further, on the screen 1000, an image of the 3D model D13 representing the overall shape of the inspection target range of the inspection target object and the comparison target object may be displayed instead of the image 1003.

The image group 1001 includes images 1001-1 to 1001-5 corresponding to the narrow angle data D12 included in the narrow angle data group DG12.

Among the images 1001-1 to 1001-5, the image 1001-5 corresponds to the comparison target narrow angle data D26 and is emphasized by a thick frame line. This enables the user to easily recognize the image 1001-5 depicting the same portion (common portion) as the image 1002 of the inspection target object, from among the image group 1001 of the comparison target object.

The images 1001-1 to 1001-5 are associated with portions P1 to P5 of the image 1003 in a form connected by curved lines. Further, the image 1002 is associated with the portion P5 of the image 1003 in a form connected by a curved line, similarly to the image 1001-5. Thus, the user can easily identify which portion of the inspection target object (excavator) the images 1001-1 to 1001-5, and 1002 are images of.

For example, the comparison inspection support part 2003 specifies, on the 3D model D13, a portion of the comparison target object reflected in the narrow angle data D12 on a per narrow angle data D12 basis included in the narrow angle data group DG12, based on the narrow angle position information data group DG16. Thus, the display processing part 2003E can associate the images 1001-1 to 1001-5 corresponding to the narrow angle data D12 included in the narrow angle data group DG12 with respective portions of the image 1003 representing the overall shape of the inspection target range of the comparison target object.

As illustrated in FIG. 11, the display processing part 2003E may cause the display device 208 to display a screen 1100.

As in the case of FIG. 9, an image 1101 corresponding to the comparison target narrow angle data D26 and an image 1102 corresponding to the narrow angle data D22 are displayed side by side on the screen 1100.

In this example, unlike the case of FIG. 9, one of the comparison target narrow angle data D26 and the narrow angle data D22 is corrected so that the difference in appearance of the same portions (common portions) of the comparison target object and the inspection target object between the image 1101 and the image 1102 is reduced.

In this example, the scale and the direction of the image corresponding to the comparison target narrow angle data D26 are corrected to generate the image 1101, and the generated image 1101 is displayed on the screen 1100 so as to be compared with the image 1102 corresponding to the narrow angle data D22. Thus, the user can more efficiently inspect a change in the previous state of the excavator by comparing the images 1101 and 1102 in which the same portions (common portions) of the inspection target object and the comparison target object are depicted and the difference in the appearance between these portions is relatively small.

The viewpoint conversion process of the first image may be performed in such a manner that a first image corresponding to one of the narrow angle data D26 and the narrow angle data D22 is matched with the position of the sensor 120 corresponding to a second image corresponding to the other. Thus, the display processing part 2003E can cause the display device 208 to display images (the image after the viewpoint conversion of the first image, and the second image) in which the same portions (common portions) are viewed in the same manner between the inspection target object and the comparison target object. Therefore, the user can more efficiently perform the comparison inspection of the inspection target object and the comparison target object by comparing two images in which the same portions (common portions) of the inspection target object and the comparison target object are depicted and the appearance between these portions is the same.

Returning to FIG. 8, the difference detection part 2003F detects the difference in shape of the same portion (common portion) of the comparison target object and the inspection target object, which is reflected in each of the comparison target narrow angle data D26 and the narrow angle data D22.

For example, the difference detection part 2003F detects a difference of a type defined in advance between the shapes of the same portions (common portions) of the comparison target object and the inspection target object corresponding to the comparison target narrow angle data D26 and the narrow angle data D22, respectively, by applying a discriminator based on a known image processing technique or machine learning. The difference in the type defined in advance may include, for example, scratches, dents, predetermined component attachment orientations, the presence or absence of predetermined components, and the like.

Further, each of the comparison target narrow angle data D26 and the narrow angle data D22 may be labeled in advance to represent a feature related to a difference in shape. The label indicating the feature related to the difference in shape includes, for example, a label indicating that there are scratches, a label indicating that there are dents, a label indicating that there are missing components, and the like.

For example, the difference detection part 2003F uses a discriminator based on a known image processing technique or machine learning to recognize the presence or absence of a feature corresponding to a target label in a target narrow angle data D12, on a per narrow angle data D12 basis and on a per label type basis. Then, when the target narrow angle data D12 has a feature corresponding to the target label, the difference detection part 2003F assigns the target label as metadata to the target narrow angle data D12. Similarly, the difference detection part 2003F recognizes the presence or absence of a feature corresponding to the target label in the narrow angle data D22, on a per label type basis. Then, when the narrow angle data D22 has a feature corresponding to the target label, the difference detection part 2003F assigns the target label as metadata to the narrow angle data D22. Thus, the difference detection part 2003F can detect the difference in shape between the same portions (common portions) of the comparison target object and the inspection target object by the difference in label assigned to each of the comparison target narrow angle data D26 and the narrow angle data D22 of the inspection target object.

The difference detection part 2003F may identify the difference in shape between the same portions (common portions) of the comparison target object and the inspection target object by recognizing the presence or absence of a difference between the comparison target narrow angle data D26 and the narrow angle data D22, on a per plurality of predefined types of difference basis.

The difference detection part 2003F may estimate the degree of difference in shape between the same portions (common portions) of the comparison target object and the inspection target object corresponding to the comparison target narrow angle data D26 and the narrow angle data D22, respectively, by applying a discriminator based on a known image processing technique or machine learning, for example.

When there are a plurality of narrow angle data D22, the difference detection part 2003F may select a plurality of combinations of the comparison target narrow angle data D26 and the narrow angle data D22 based on the content and degree of the difference in shape between the same portions (common portions) of the comparison target object and the inspection target object.

When the display processing part 2003E displays the comparison target narrow angle data D26 and the narrow angle data D22 on the display device 208, the display processing part 2003E may reflect the detection result of the difference detection part 2003F on the display contents.

For example, the display processing part 2003E displays the comparison target narrow angle data D26 and the narrow angle data D22 on the display device 208 so as to emphasize the difference in shape between the comparison target object and the inspection target object corresponding to the comparison target narrow angle data D26 and the narrow angle data D22, respectively. Specifically, the display processing part 2003E may display a marker at an image portion where a difference occurs between two images corresponding to the comparison target narrow angle data D26 and the narrow angle data D22. Further, when the shape of the inspection target object corresponding to the narrow angle data D22 has a feature that is not present in the shape of the comparison target object corresponding to the comparison target angle data narrow D26, the display processing part 2003E may cause the display device 208 to display the narrow angle data D22 so as to make the feature portion conspicuous. For example, the display processing part 2003E performs image processing to exaggerate the amount of scratches, dents, or the like of the inspection target object, which is present in the image corresponding to the narrow angle data D22, and causes the display device 208 to display the narrow angle data D22.

The display processing part 2003E may cause the display device 208 to display an image representing the overall shape of the inspection target range of the inspection target object and the comparison target object in association with information related to the difference in the portion in which the difference in the shape between the comparison target object and the inspection target object is detected by the difference detection part 2003F. For example, the display processing part 2003E displays the information on the difference in association with a portion of the image representing the overall shape of the inspection target range of the inspection target object and the comparison target object, where the portion of the image corresponds to each of portions of the inspection target object and the comparison target object in which the difference in shape is detected by the difference detection part 2003F. The information on the difference includes, for example, summary information indicating the content and degree of the difference.

When there are a plurality of narrow angle data D22, the display processing part 2003E may cause the display device 208 to display a plurality of combinations of the comparison target narrow angle data D26 and the narrow angle data D22 in a distinguishable manner according to the content and degree of the difference selected by the difference detection part 2003F.

In this way, the inspection support apparatus 200 can estimate the position and the orientation of the sensor 110 corresponding to the wide angle data D11, based on the wide angle data group DG11 of the comparison target object. Thus, the inspection support apparatus 200 can estimate the position and the orientation of the sensor 120 corresponding to the narrow angle data D12, based on the sensor relative position information data D15, on the assumption that the relative positional relationship between the sensors 110 and 120 is fixed. The inspection support apparatus 200 can estimate the position and the orientation of the sensor 110 corresponding to the wide angle data D21 of the inspection target object, based on the information on the wide angle data group DG11 of the comparison target object and the position and the orientation of the sensor 110 corresponding to the wide angle data D11. Thus, the inspection support apparatus 200 can estimate the position and the orientation of the sensor 120 corresponding to the narrow angle data D22 of the inspection target object, based on the sensor relative position information data D24 on the assumption that the relative positional relationship between the sensors 110 and 120 is fixed. Therefore, the inspection support apparatus 200 can extract a combination of the narrow angle data D12 and D22 representing the shapes of the same portions (common portions) of the inspection target object and the comparison target object, based on the information on the position and orientation of the sensor 120 corresponding to each of the narrow angle data D12 and D22. Therefore, the user can identify the detailed shapes of the same portions (common portions) of the comparison target object and the inspection target object, based on the narrow angle data D12 and D22 while identifying the overall shape of the inspection range of the comparison target object and the inspection target object, based on the wide angle data D11 and D21. As a result, the user can perform the comparison inspection more appropriately.

### Other Embodiments

Next, other embodiments will be described.

The above-described embodiment may be modified or changed as appropriate.

For example, in the above-described embodiment, the 3D model D13 of the comparison target object and the narrow angle data group DG12 in which a portion of the comparison target object or a portion of the 3D model D13 is identified for each narrow angle data D12 may be prepared in advance, and stored in a predetermined storage part. The 3D model D13 of the comparison target object is, for example, a three dimensional computer-aided design model (CAD) of final specifications at the time of designing the comparison target object.

In this case, the wide angle data group DG11 of the comparison target object may be omitted, and the narrow angle data position estimating part 2002C may estimate the position and the orientation of the sensor 120 corresponding to the narrow angle data D12 on a per narrow angle data D12 basis, based on the 3D model D13. For example, the narrow angle data position estimating part 2002C applies, on a per narrow angle data D12 basis, a known correspondence point search method, based on the narrow angle data D12 and data on the shape of the portion of the 3D model D13 corresponding to the portion of the comparison target object specified for the narrow angle data D12. This enables the narrow angle data position estimating part 2002C to estimate the position and orientation of the sensor 120 corresponding to the narrow angle data D12 on the coordinate system of the 3D model D13, based on the combination of the plurality of corresponding points obtained as a result of the search.

In this case, the wide angle data position estimating part 2003A may perform known SfM processing using a wide angle data group including a large number of wide angle data D21 of the inspection target object. This enables the wide angle data position estimating part 2003A to generate a three dimensional model of the inspection target object and estimate the position and orientation of the sensor 110 corresponding to each of the wide angle data D21. At this point, the coordinate system in which the three dimensional model and the position and orientation of the sensor 120 corresponding to each of the wide angle data D21, of the inspection target object, are represented is processed so as to be the same as the coordinate system of the 3D model D13 of the comparison target object. For example, the coordinate system of the three dimensional model of the inspection target object is aligned with the coordinate system of the 3D model D13, based on the comparison between the three dimensional model of the inspection target object obtained by the SEM processing and the 3D model D13 of the comparison target object. This enables the comparison target data searching part 2003D to search for the comparison target narrow angle data D26 corresponding to the target narrow angle data D22, based on the narrow angle position information data group DG16 and the narrow angle position information data D25 represented by the coordinate system of the 3D model D13.

In the above-described embodiment, the user may perform inspection of a single inspection target object alone without using the comparison target object (hereinafter, referred to as “single inspection”), based on the narrow angle data D22 of the inspection target object, instead of the comparison inspection or as a preliminary inspection before the detailed comparison inspection. For example, the presence or absence of scratches, dents, or missing components may be inspected even by a single inspection target object.

In this case, the comparison target data generating part 2002 is omitted. The wide angle data position estimating part 2003A may perform known SfM processing using a wide angle data group including a large number of wide angle data D21 of the inspection target object. This enables the wide angle data position estimating part 2003A to generate a three dimensional model of the inspection target object and estimate the position and orientation of the sensor 120 corresponding to each of the wide angle data D21. Further, instead of the comparison target data searching part 2003D, a functional part is provided that specifies a portion of the inspection target object corresponding to the narrow angle data D22, based on the narrow angle position information data D25, and associates the narrow angle data D22 with the specified portion using a database or the like. This enables, for example, the display processing part 2003E to associate the narrow angle data D22 with the portion corresponding to the narrow angle data D22 on the image representing the overall shape of the inspection target range of the inspection target object when displaying the narrow angle data D22 and the image representing the overall shape of the inspection target range on the display device 208. Therefore, the user can identify the portion of the inspection target object represented by the narrow angle data D22. Accordingly, the user can identify the detailed shape of each of the portions of the inspection target object based on the narrow angle data D22 while identifying the overall shape of the inspection target object, based on the wide angle data D21. As a result, the user can more appropriately perform the single inspection.

In the embodiment and the modifications and variations thereof, instead of or in addition to the display of the narrow angle data D22 and the comparison target narrow angle data D26 on the display device 208, a combination of the narrow angle data D22 and the comparison target narrow angle data D26 may be transmitted to the outside. For example, the inspection support apparatus 200 transmits a combination of the narrow angle data D22 and the comparison target narrow angle data D26 to the terminal device 300. Thus, for example, the user can receive information on a combination of the narrow angle data D22 and the comparison target narrow angle data D26 by using the function of the server-side inspection support apparatus 200 through the client-side terminal device 300. Therefore, the user can perform the comparison inspection without being restricted by the place where the inspection support apparatus 200 is installed.

In the above-described embodiment and the examples of the modifications and changes thereof, the sensor device 100 may be incorporated in the inspection support apparatus 200 or the terminal device 300. For example, the inspection support apparatus 200 and the terminal device 300 are a smartphone and a tablet terminal equipped with a camera, a LiDAR, and the like as the sensor device 100.

### Operation

Next, the operation of the information processing apparatus according to the present embodiment will be described.

In the present embodiment, the information processing apparatus includes a first acquisition part, a second acquisition part, and an association part. The information processing apparatus is, for example, the above-described inspection support apparatus 200. The first acquisition part and the second acquisition part are, for example, the data acquisition part 2001 described above. The association part is, for example, the comparison target data searching part 2003D described above. The functions of the first acquisition part, the second acquisition part, and the association part may be implemented by a program that causes an information processing apparatus to execute a first acquisition step, a second acquisition step, and an association step corresponding to the first acquisition part, the second acquisition part, and the association part, respectively. Specifically, the first acquisition part acquires first sensing data representing a shape of a relatively narrow range of the first target object, and second sensing data representing a shape of a relatively wide range of the first target object and for which a relationship in position and orientation between sensors at a time of acquisition is predefined with respect to the first sensing data. The first target object is, for example, the above-described inspection target object. The first sensing data is, for example, the above-described narrow angle data D22. The sensors include, for example, the sensor 110 and the sensor 120. The second sensing data is, for example, the above-described wide angle data D21. The second acquisition part acquires a third sensing data group and a fourth sensing data group. The third sensing data group is a collection of third sensing data each representing a shape of a relatively narrow range of a second target object to be compared with the first target object, and the fourth sensing data group is a collection of fourth sensing data each representing a shape of a relatively wide range of the second target object and for which a relationship in position and orientation between the sensors at the time of acquisition of the third sensing data and the fourth sensing data is predefined with respect to the third sensing data. The second target object is, for example, the above-described comparison target object. The third sensing data is, for example, the above-described narrow angle data D12. The sensors include, for example, the sensor 110 and the sensor 120. The fourth sensing data is, for example, the above-described wide angle data D11. The third sensing data group is, for example, the above-described narrow angle data group DG12. The fourth sensing data group is, for example, the above-described wide angle data group DG11. Then, the association part associates, based on the second sensing data and the fourth sensing data group, the first sensing data with the third sensing data, the third sensing data corresponding to a portion of the second target object that is the same portion (common portion) (i.e., representing the same portion) as the portion of the first target object corresponding to the first sensing data.

For example, when sensing data representing the shape of a relatively narrow range, such as image data with a relatively narrow viewing angle, is used, the detailed shape of the range can be reflected in the data. Therefore, the state of the range of the target object can be determined in more detail.

However, in the sensing data representing the shape of a relatively narrow range, it may not be possible to determine which range of the overall inspection target range of the target object that data corresponds to. Therefore, for example, sensing data of an inspection target portion cannot be appropriately extracted from the sensing data group, and as a result, there is a possibility that inspection cannot be appropriately performed.

For example, in a case where sensing data representing a shape of a relatively wide range such as image data having a relatively wide viewing angle is used, it is easy to determine a portion corresponding to a range of data in the overall inspection target range of the target object.

However, in the sensing data representing a shape of a relatively wide range, a detailed shape is less likely to be reflected in the data. Therefore, the state of the range included in the sensing data cannot be determined in detail, and as a result, there is a possibility that the inspection cannot be appropriately performed.

In contrast, the information processing apparatus can capture the overall shape of the inspection target range of the first and second target objects based on the second sensing data and the fourth sensing data group representing the shapes of relatively wide ranges, for example. Further, the information processing apparatus can identify a portion of the first target object represented by the first sensing data, which represents a shape of a relatively narrow range and a portion of the second target object represented by the third sensing data, which represents a shape of a relatively narrow range, for example, based on a relationship in position and orientation between the sensors. Therefore, the information processing apparatus can associate the first and third sensing data corresponding to the same portions (common portions) of the first and second target objects. Therefore, the user can more appropriately perform the comparison inspection by using the first and third sensing data representing the relatively narrow ranges of the first and second target objects.

In the present embodiment, the first target object and the second target object may be the same object at different points in time from each other. The first target object and the second target object may be different objects of the same design.

Thus, the information processing apparatus can support inspection of a change in the same target object in time series, and can also support inspection of a difference between different target objects having the same design.

In the present embodiment, the information processing apparatus may include a first estimation part, a second estimation part, a third estimation part, and a fourth estimation part. The first estimation part is, for example, the SfM processing part 2002A described above. The second estimation part is, for example, the above-described narrow angle data position estimating part 2002C. The third estimation part is, for example, the wide angle data position estimating part 2003A described above. The fourth estimation part is, for example, the above-described narrow angle data position estimating part 2003C. Specifically, the first estimation part estimates a position and an orientation of a sensor corresponding to the fourth sensing data on a per fourth sensing data basis, based on the fourth sensing data group. The second estimation part estimates a position and an orientation of a sensor corresponding to the third sensing data on a per third sensing data basis, based on the estimation results of the first estimation part. The third estimation part estimates the position and the orientation of a sensor corresponding to the second sensing data, based on the fourth sensing data group and the estimation results of the first estimation part. The fourth estimation part estimates a position and an orientation of a sensor corresponding to the first sensing data, based on the estimation results of the third estimation part. The association part may associate the first sensing data with the third sensing data corresponding to a portion of the second target object that is the same portion (common portion) as a portion of the first target object corresponding to the first sensing data (i.e., representing the same portion), based on the estimation results of the position and orientation of the sensor corresponding to the first sensing data by the fourth estimation part and the estimation results of the position and orientation of the sensor corresponding to the third sensing data on a per third sensing data basis by the second estimation part.

Thus, the information processing apparatus can identify the position and the orientation of the sensor corresponding to each of the first and third sensing data, and associate the first and third sensing data corresponding to the same portions (common portions) of the first and second target objects.

In the present embodiment, the first estimation part may estimate the position and the orientation of the sensor corresponding to the fourth sensing data on a per fourth sensing data basis, based on the relationship between the fourth sensing data each representing the same portion (common portion) of the second target object included in the fourth sensing data group.

This enables the information processing apparatus to estimate the position and the orientation of the sensor corresponding to the fourth sensing data on a per fourth sensing data basis from the fourth sensing data group.

In the present embodiment, the information processing apparatus may include a detection part. The detection part is, for example, the difference detection part 2003F. Specifically, the detection part may detect a difference between the same portions (common portions) of the first target object and the second target object, based on the first sensing data and the third sensing data associated by the association part.

This enables the user to perform a comparison inspection using the detection result. Therefore, the information processing apparatus can improve the convenience of the user and can improve the efficiency of the comparison inspection.

In the present embodiment, the detection part may select, from among the same portions (common portions) of the first target object and the second target object, portions between which a difference is detected, according to at least one of the content of the difference and the degree of the difference.

Thus, for example, the user can be provided with information only on a combination of the first and third sensing data corresponding to a portion limited by at least one of the content of the difference and the degree of the difference, from among the same portions (common portions) of the first and second target objects. Therefore, the information processing apparatus can improve the convenience of the user and can improve the efficiency of the comparison inspection.

In the present embodiment, the detection part may label the first sensing data and the third sensing data associated by the association part to represent respective features, and detect a difference between the same portions (common portions) of the first target object and the second target object, based on a difference between the labels of the data.

Thus, the information processing apparatus can detect the difference between the same portions (common portions) of the first and second target objects.

In the present embodiment, the information processing apparatus may include a display part configured to display the first sensing data and the third sensing data associated by the association part.

Thus, the information processing apparatus can provide the user with information on the first and third sensing data corresponding to the same portions (common portions) of the first and second target objects by a visual method.

In the present embodiment, the display part may display the first sensing data and the third sensing data associated with each other by the association part with a difference in shape emphasized.

Thus, the information processing apparatus can more easily recognize the difference in shape between the first and third sensing data corresponding to the same portions (common portions) of the first and second target objects. Therefore, the information processing apparatus can improve the convenience of the user and can improve the efficiency of the comparison inspection.

In the present embodiment, the display part may display an image representing the overall shape of the inspection target range of the first target object and the second target object.

Thus, the user can perform the comparison inspection while checking not only the combination of the sensing data for the specific portions but also the image representing the overall shape of the inspection target range of the first and second target objects. Therefore, the information processing apparatus can improve the convenience of the user and can improve the efficiency of the comparison inspection.

In the present embodiment, the display part may display the first sensing data and the third sensing data associated by the association part in association with the portions of the overall image.

This enables the user to easily identify the locations of the portions corresponding to the first and third sensing data displayed on the display part by comparing these portions with portions in the image representing the overall shape of the inspection range of the first and second objects. Therefore, the information processing apparatus can improve the convenience of the user and can improve the efficiency of the comparison inspection.

In the present embodiment, the display part may display information on a difference between the same portions (common portions) of the first target object and the second target object corresponding to the first sensing data and the third sensing data associated by the association part (i.e., represented by these data) in association with a portion of the image representing the overall shape of the inspection target range of the first target object and the second target object.

This enables the user to easily identify the locations of the portions of the first and second objects corresponding to the first and third sensing data displayed on the display part by comparing these portions with the portions of the image representing the overall shape of the first and second objects. Therefore, the information processing apparatus can improve the convenience of the user and can improve the efficiency of the comparison inspection.

In the present embodiment, the information processing apparatus may include a first acquisition part, a storage part, and an association part. Specifically, the first acquisition part acquires a first sensing data group and a second sensing data group. The first sensing data group is a collection of first sensing data representing a shape of a relatively narrow range of the first target object, and the second sensing data group is a collection of second sensing data representing a shape of a relatively wide range of the first target object and for which a relationship in position and orientation between the sensors at the time of acquisition of the first sensing data and the second sensing data is predefined with respect to the first sensing data. The storage part stores three dimensional shape data of an inspection target range of a second target object as a comparison target of the first target object and a third sensing data group. The third sensing data group is a collection of third sensing data representing a shape of the second target object and for which a correspondence relationship with a portion of the second target object or the three dimensional shape data is predefined. The association part associates, based on the second sensing data group and the three dimensional shape data of the second target object, the first sensing data and the third sensing data, the first sensing data representing a portion of the first target object and the third sensing data representing a portion of the second target object that is a same portion (common portion) as the portion of the first target object (i.e., representing the same portion).

Accordingly, the information processing apparatus can capture the overall shape of the inspection target range of the first and second target objects based on the second sensing data group and the three dimensional shape data, for example. Further, the information processing apparatus can identify a portion of the first target object represented by the first sensing data, which represents a shape of a relatively narrow range, and a portion of the second target object represented by the third data, which represents a shape of a relatively narrow range, for example, based on a relationship in position and orientation between the sensors. Therefore, the information processing apparatus can associate the first and third sensing data corresponding to the same portions (common portions) of the first and second target objects. Therefore, the user can more appropriately perform the comparison inspection by using the first and third sensing data representing the relatively narrow ranges of the first and second target objects.

In the present embodiment, the information processing apparatus may include a first acquisition part and an association part. Specifically, the first acquisition part acquires a first sensing data group and a second sensing data group which are a collection of first sensing data representing a shape of a relatively narrow range of the first target object and a collection of second sensing data representing a shape of a relatively wide range of the first target object and for which a relationship in position and orientation between sensors at the time of acquisition of the first sensing data and the second sensing data is predefined with respect to the first sensing data. Then, the association part associates the second sensing data with the portion of the first target object corresponding to the second sensing data (i.e., represented by the data) based on the first sensing data group.

With this configuration, the information processing apparatus can capture the overall shape of the inspection target range of the first target object, based on the second sensing data group, for example. In addition, the information processing apparatus can identify a portion of the first target object represented by the first sensing data representing a shape in a relatively narrow range, for example, based on the relationship between the positions and orientations of the sensors. Therefore, the information processing apparatus can associate the second sensing data with the portion of the first target object corresponding to the second sensing data. Therefore, the user can identify the portion of the first target object corresponding to the first sensing data representing the relatively narrow range of the first target object, and then can more appropriately perform the single inspection using the first sensing data.

Although the embodiments have been described in detail, the present disclosure is not limited to such specific embodiments, and various modifications and changes can be made within the scope of the gist described in the claims.

Finally, the present application claims priority to Japanese Patent Application No. 2022-156595 filed on Sep. 29, 2022, the entire contents of which are incorporated herein by reference.

What is claimed is:

1. An information processing apparatus comprising:
a processor; and
a memory storing instructions that cause the processor to execute a process, the process including
acquiring first sensing data and second sensing data, the first sensing data representing a shape of a relatively narrow range of a first target object, and the second sensing data representing a shape of a relatively wide range of the first target object and for which a relationship in position and orientation between sensors at a time of acquisition of the first sensing data and the second sensing data is predefined with respect to the first sensing data;
acquiring a third sensing data group and a fourth sensing data group, the third sensing data group being a collection of third sensing data, the third sensing data representing a shape of a relatively narrow range of a second target object, the second target object being a comparison target of the first target object, and the fourth sensing data group being a collection of fourth sensing data, the fourth sensing data representing a shape of a relatively wide range of the second target object and for which a relationship in position and orientation between the sensors at a time of acquisition of the third sensing data and the fourth sensing data is predefined with respect to the third sensing data; and
associating, based on the second sensing data and the fourth sensing data group, the first sensing data with the third sensing data, the third sensing data representing a portion of the second target object that is a same portion as a portion of the first target object corresponding to the first sensing data.

2. The information processing apparatus according to claim 1, wherein the first target object and the second target object are a same object at different points in time from each other, or different objects of a same design.

3. The information processing apparatus according to claim 2, wherein the process further includes
estimating a position and an orientation of a sensor corresponding to the fourth sensing data on a per fourth sensing data basis, based on the fourth sensing data group;
estimating a position and an orientation of a sensor corresponding to the third sensing data on a per third sensing data basis, based on estimation results of estimating of the position and the orientation of the sensor corresponding to the fourth sensing data;
estimating a position and an orientation of a sensor corresponding to the second sensing data, based on the fourth sensing data group and the estimation results; and
estimating a position and an orientation of a sensor corresponding to the first sensing data, based on estimation results of estimating of the position and the orientation of the sensor corresponding to the second sensing data,
wherein the associating includes associating the first sensing data with the third sensing data, the third sensing data representing the portion of the second target object that is the same portion as the portion of the first target object, based on estimation results of the position and orientation of the sensor corresponding to the first sensing data and estimation results of the position and orientation of the sensor corresponding to the third sensing data on a per third sensing data basis.

4. The information processing apparatus according to claim 3, wherein the position and the orientation of the sensor corresponding to the fourth sensing data on a per fourth sensing data basis is estimated based on a relationship between the fourth sensing data each representing a same portion of the second target object included in the fourth sensing data group.

5. The information processing apparatus according to claim 1, wherein the process further includes
detecting a difference between same portions of the first target object and the second target object, based on the first sensing data and the third sensing data associated in the associating.

6. The information processing apparatus according to claim 5, wherein the detecting includes selecting portions between which a difference is detected, from among the same portions of the first target object and the second target object, according to at least one of a content of the difference or a degree of the difference.

7. The information processing apparatus according to claim 5, wherein the detecting includes labeling the first sensing data and the third sensing data associated in the associating to represent features, and detecting a difference between the same portions of the first target object and the second target object, based on a difference between the labels of the first sensing data and the second sensing data.

8. The information processing apparatus according to claim 1, wherein the process further includes
displaying the first sensing data and the third sensing data associated in the associating.

9. The information processing apparatus according to claim 8, wherein the displaying includes displaying the first sensing data and the third sensing data associated with each other in the associating with a difference in shape emphasized.

10. The information processing apparatus according to claim 8, wherein the displaying includes displaying an image representing an overall shape of an inspection target range of the first target object and the second target object.

11. The information processing apparatus according to claim 10, wherein the displaying includes displaying the first sensing data and the third sensing data associated in the associating in association with a portion of the image.

12. The information processing apparatus according to claim 10, wherein the displaying includes displaying, in association with a portion of the image, information on a difference between same portions of the first target object and the second target object represented by the first sensing data and the third sensing data associated in the associating.

13. An information processing apparatus comprising:
a processor; and
a memory storing instructions that cause the processor to execute a process, the process including
acquiring a first sensing data group and a second sensing data group, the first sensing data group being a collection of first sensing data, the first sensing data representing a shape of a relatively narrow range of a first target object, and the second sensing data group 25 being a collection of second sensing data, the second sensing data representing a shape of a relatively wide range of the first target object and for which a relationship in position and orientation between sensors at a time of acquisition of the first sensing data and the 30 second sensing data is predefined with respect to the first sensing data;
storing three dimensional shape data of a second target object as a comparison target of the first target object and a third sensing data group, the third sensing data group being a collection of third sensing data, the third sensing data representing a shape of the second target object and for which a correspondence relationship with a portion of the second target object or the three dimensional shape data is predefined; and
associating, based on the second sensing data group and the three dimensional shape data of the second target object, the first sensing data and the third sensing data, the first sensing data representing a portion of the first target object, and the third sensing data representing a portion of the second target object that is a same portion as the portion of the first target object.

14. An information processing apparatus comprising:
a processor; and
a memory storing instructions that cause the processor to execute a process, the process including
acquiring a first sensing data group and a second sensing data group, the first sensing data group being a collection of first sensing data, the first sensing data representing a shape of a relatively narrow range of a first target object, and the second sensing data group being a collection of second sensing data, the second sensing data representing a shape of a relatively wide range of the first target object and for which a relationship in position and orientation between sensors at a time of acquisition of the first sensing data and the second sensing data is defined in advance; and
associating the second sensing data with a portion of the first target object represented by the second sensing data, based on the first sensing data group.
